(19) United States
(12) Patent Application Publication
(10) Pub. No.: US 2006/0149849 A1
(43) Pub. Date: Jul. 6, 2006

(54) System for parameterized processing of streaming data

(76) Inventor: Gilad Raz, Mevaseret Tzion (IL)

Correspondence Address: DANIEL J SWIRSKY, 55 REUVEN ST., BEIT SHEMESH, 99544, IL

(21) Appl. No.: 11/027,673

(22) Filed: Jan. 3, 2005

(51) Int. Cl. G06F 15/16

(52) U.S. Cl. 709/231; 707/206

(57) ABSTRACT

A method for processing streaming data, the method including receiving a selection of at least one streaming data source, creating an event stream in a stream database from streaming data from the selected data source, receiving a selection of at least one flow including at least one predefined operation for application to the event stream, receiving a value for at least one variable in the selected flow, and applying the flow to the event stream using the variable values.

### FIELD OF THE INVENTION

The present invention relates to streaming data processing in general, and more particularly to the parameterized processing of streaming data.

### BACKGROUND OF THE INVENTION

Streaming data processing has the potential of placing real-time information in the hands of decision makers. Streaming data typically arrives from one or more data sources and may be aggregated in a centralized repository. A data source may be as erratic as traffic accident reports or as dependable and uniform as a clock. The timely arrival of streaming data arriving from the data sources may provide crucial information necessary for on-time decisions. For example, the analysis of traffic reports may indicate a faulty roadway and enable those responsible for roadway maintenance to react appropriately.

The dynamic nature of streaming data, being that it's constantly in motion, makes it difficult to process. While other data may be processed at discrete points in time, streaming data, by definition, represents a continuous flow of information that must be continually processed.

Moreover, the wide range of applications that may utilize streaming data makes developing a generalized tool difficult. Streaming data sources are latent in many environments, and each environment may have numerous uses for the streaming data. Tailoring a processing tool for each application within each environment is typically not economically feasible.

### SUMMARY OF THE INVENTION

The present invention discloses a system and method for processing streaming data that is adapted for use with various applications and environments.

In one aspect of the present invention a method is provided for processing streaming data, the method including a) receiving a selection of at least one streaming data source, b) creating an event stream in a stream database from streaming data from the selected data source, c) receiving a selection of at least one flow including at least one predefined operation for application to the event stream, d) receiving a value for at least one variable in the selected flow, and e) applying the flow to the event stream using the variable values.

In another aspect of the present invention the method further includes recording in the stream database a temporal aspect of the time of insertion of the data into the stream database.

In another aspect of the present invention the method further includes predefining the flow in an XML document.

In another aspect of the present invention the method further includes predefining a metric for any of the variables.

In another aspect of the present invention the receiving step d) includes receiving a measure of success for any of the variables.

In another aspect of the present invention the method further includes predefining a service level agreement (SLA) flow including a variable for storing a measure of successful service compliance of a service request.

In another aspect of the present invention a system is provided for processing streaming data, the system including a) means for receiving a selection of at least one streaming data source, b) means for creating an event stream in a stream database from streaming data from the selected data source, c) means for receiving a selection of at least one flow including at least one predefined operation for application to the event stream, d) means for receiving a value for at least one variable in the selected flow, and e) means for applying the flow to the event stream using the variable values.

In another aspect of the present invention the system further includes means for recording in the stream database a temporal aspect of the time of insertion of the data into the stream database.

In another aspect of the present invention the system further includes means for predefining the flow in an XML document.

In another aspect of the present invention the system further includes means for predefining a metric for any of the variables.

In another aspect of the present invention the means for receiving is operative to receive a measure of success for any of the variables.

In another aspect of the present invention the system further includes means for predefining a service level agreement (SLA) flow including a variable for storing a measure of successful service compliance of a service request.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a system for processing streaming data, constructed and operative in accordance with a preferred embodiment of the present invention;

FIG. 1B and 1C, taken together, is a simplified flowchart illustration of a method for processing streaming data, operative in accordance with a preferred embodiment of the present invention; and

FIG. 2 is a simplified flowchart illustration of an exemplary method for parameterized processing of streaming data, operative in accordance with a preferred embodiment of the present invention.

### DETAILED DESCRIPTION OF PREFERRED EMBODIMENTS

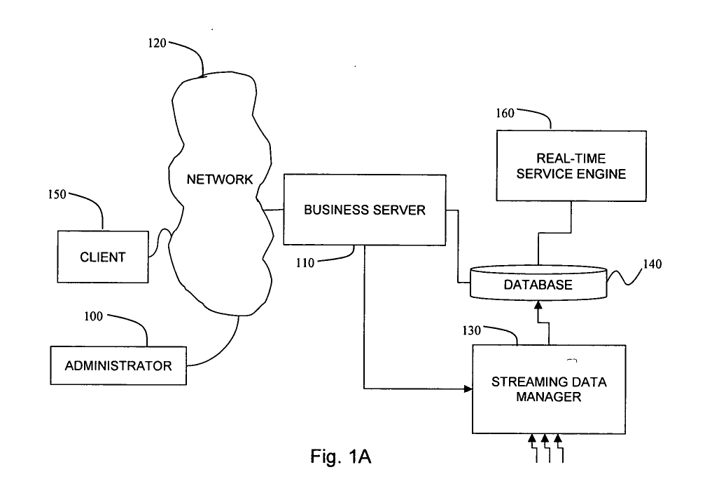

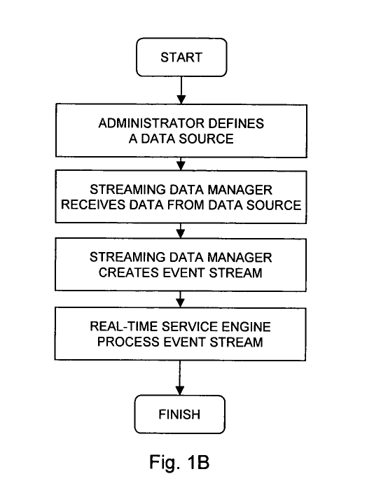

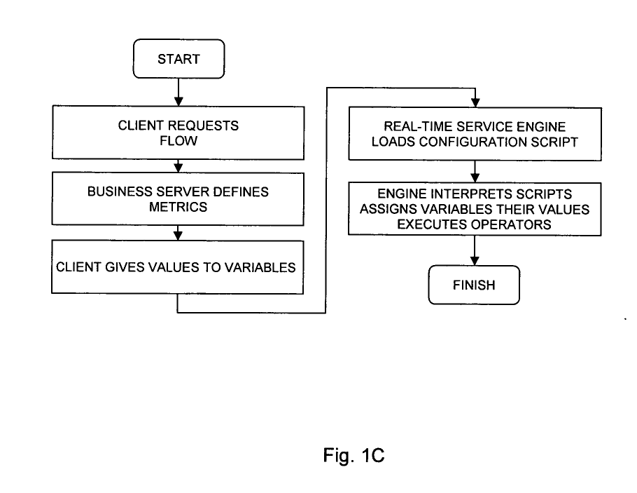

Reference is now made to FIG. 1A, which is a simplified pictorial illustration of a system for processing streaming data, constructed and operative in accordance with a preferred embodiment of the present invention, and to FIGS. 1B and 1C, which, taken together, is a simplified flowchart illustration of a method for processing streaming data, operative in accordance with a preferred embodiment of the present invention. In the system of FIG. 1A, an administrator computer 100 preferably requests a list of available data sources from a business server 110. This request preferably takes the form of an HTTP request over a network 120, such as an Intranet. Business server 110 preferably communicates with a streaming data manager 130, which may have access to one or more data sources, and constructs the list of available data sources that are known to business server 110. Administrator computer 100 may then choose a particular data source from the list and communicate properties of the data source, such as the format of data available in the data source, to business server 110. Business server 110 preferably communicates the properties of the data source received from administrator computer 100 to streaming data manager 130, which may employ the properties to import data from the data source selected by administrator computer 100 to a database 140.

For example, a large corporation may keep track of the number of service requests made by its employees to a service provider. For each service request, the duration of the request, which may be defined as the time measured from the call for service until the resolution of the request by the service provider, is entered into a central heap of data, known as a ‘service heap’. The service heap may be implemented as a set of flat files, with each file containing the service request entries entered in the past 30 minutes. Thus, the first flat file of a given day may contain service requests entered between 8:00 am and 8:30 am, while the second file may contain service requests entered between 8:30 am and 9:00 am. Each entry in the service heap may be constructed as a single line of text that includes multiple comma delimited columns, such as the following column:
Type, duration
1, 30:10
   where the first column specifies the type of the service request, and the second column specifies the duration of the request.

Multiple heaps of data may exist each pertaining to a different data source, such as a ‘service heap’, ‘computer heap’ and ‘telephone heap’. When administrator computer 100 requests the list of available data sources from business server 110, business server 110 may create the following list:
Service Heap
Computer Heap
Telephone Heap
   Administrator computer 100 may choose the ‘service heap’ as the data source and communicate to business server 110 the properties of the selected data source, such as the structure of the entries in the service heap data, providing labels for each column, such as the label ‘DUR’ for the column ‘duration’.

In the method of FIG. 1B, business server 110 configures streaming data manager 130 on the basis of the properties provided by administrator computer 100. Streaming data manager 130 may then retrieve the data from the data source selected by administrator computer 100. Streaming data manager 130 preferably inserts the data into database 140, recording the temporal aspect of the time of insertion of the data into database 140 to create an Event Stream utilizing any well known technique, such as the relational model with period-timestamped tuples referred to by M. Böhlen, Temporal Database System Implementations. SIGMOD, 24(4), 1995.

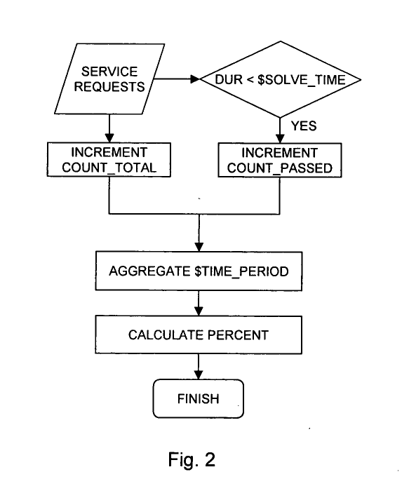

In the method of FIG. 1C, a client computer 150 may request a set of available flows from business server 110 via network 120, and assign values to variables in the flow that may define a measure of success. A flow preferably defines a set of operations performed on one or more Event Streams. Business server 110 preferably includes a set of predefined flows available for typical business applications, such as a Service Level Agreement (SLA) flow, described in greater detail hereinbelow with reference to FIG. 2. Business server 110 may construct a set of metrics that define the scope of the variables employed in a particular type of flow, which may incorporate information provided by administrator computer 100. The parameters of a flow, which include the metrics, operations and corresponding Event Streams are preferably encapsulated in a configuration script, such as may be constructed in the form of an XML document. For example, the parameters of a flow that utilizes the operator ‘filter’ to search an Event Stream for service requests with a specific request duration may be encapsulated in the following configuration script:

<Operator op=filter stream=ServiceRequests>

<Config>

<Sql><![CDATA[@DUR < $SOLVE_TIME]]></Sql>

</Config>

</Operator>

where labels proceeded by a ‘$’ denote variables to be assigned values by client computer 150, and those preceded by ‘@’ denote fields, such as may be expressed as labels of columns, in the Event Stream. Business server 110 preferably stores the configuration script and the values assigned to the variables in database 140.

The system of FIG. 1A preferably includes a real-time service engine 160, capable of retrieving and processing configuration scripts and variables with their associated values from database 140. Real-time service engine 160 preferably interprets the configuration script, replacing the variables with their corresponding values, and processes the Event Streams with the operators specified, creating an output stream of resultant data.

Reference is now made to FIG. 2, which is a simplified flowchart illustration of an exemplary method for parameterized processing of streaming data, operative in accordance with a preferred embodiment of the present invention. The method of FIG. 2 defines an SLA flow that may be processed by real-time service engine 160 (FIG. 1A). The SLA flow receives a service request Event Stream and defines two metrics, COUNT_TOTAL and COUNT_PASSED. COUNT_TOTAL is incremented for each service request received. COUNT_PASSED represents a measure of successful service compliance that is only incremented if the duration, defined as the time measured from the call for service until the resolution of the request by the service provider, is smaller than a predefined time, expressed in the variable $SOLVE_TIME. The two metrics are calculated for the Event Stream during a time period, defined by the variable $TIME_PERIOD. The SLA flow outputs the percentage of service requests that have been resolved within $SOLVE_TIME over the last $TIME_PERIOD.

For example, assuming the value assigned to the variables $SOLVE_TIME and $TIME_PERIOD were 45 minutes and 12 hours respectively, the SLA flow would calculate the number of service requests that were resolved within 45 minutes in the last 12 hours.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for processing streaming data, the method comprising:
a) receiving a selection of at least one streaming data source;
b) creating an event stream in a stream database from streaming data from said selected data source;
c) receiving a selection of at least one flow comprising at least one predefined operation for application to said event stream;
d) receiving a value for at least one variable in said selected flow; and
e) applying said flow to said event stream using said variable values.

2. A method according to claim 1 and further comprising recording in said stream database a temporal aspect of the time of insertion of said data into said stream database.

3. A method according to claim 1 and further comprising predefining said flow in an XML document.

4. A method according to claim 1 and further comprising predefining a metric for any of said variables.

5. A method according to claim 1 wherein said receiving step d) comprises receiving a measure of success for any of said variables.

6. A method according to claim 1 and further comprising predefining a service level agreement (SLA) flow including a variable for storing a measure of successful service compliance of a service request.

7. A system for processing streaming data, the system comprising:
a) means for receiving a selection of at least one streaming data source;
b) means for creating an event stream in a stream database from streaming data from said selected data source;
c) means for receiving a selection of at least one flow comprising at least one predefined operation for application to said event stream;
d) means for receiving a value for at least one variable in said selected flow; and
e) means for applying said flow to said event stream using said variable values.

8. A system according to claim 7 and further comprising means for recording in said stream database a temporal aspect of the time of insertion of said data into said stream database.

9. A system according to claim 7 and further comprising means for predefining said flow in an XML document.

10. A system according to claim 7 and further comprising means for predefining a metric for any of said variables.

11. A system according to claim 7 wherein means for receiving is operative to receive a measure of success for any of the variables.

12. A system according to claim 7 and further comprising means for predefining a service level agreement (SLA) flow including a variable for storing a measure of successful service compliance of a service request.
